(19) United States
(12) Patent Application Publication
(10) Pub. No.: US 2026/0090929 A1
(43) Pub. Date: Apr. 2, 2026

(54) WHEELCHAIR-ANCHOR ASSEMBLY

(71) Applicant: Ford Global Technologies, LLC, Dearborn, MI (US)

(72) Inventors: Mohammad Omar Faruque, Ann Arbor, MI (US); S.M. Iskander Farooq, Novi, MI (US); Dean M. Jaradi, Macomb, MI (US)

(73) Assignee: Ford Global Technologies, LLC, Dearborn, MI (US)

(21) Appl. No.: 18/898,817

(22) Filed: Sep. 27, 2024

(51) Int. Cl. A61G 3/08

(52) U.S. Cl. CPC A61G 3/0808

(57) ABSTRACT

A wheelchair-anchor assembly for a vehicle includes a track having a longitudinal axis and a shuttle moveably engaged with the track. The shuttle is moveable relative to the track along the longitudinal axis. Two hook assemblies are adjustably supported by the shuttle. The hook assemblies are moveable relative to the shuttle to hooking positions. The hook assemblies each include a hook. The hooks oppose each other along the longitudinal axis in the hooking positions.

### BACKGROUND

Passenger vehicles are not typically designed to accommodate wheelchairs. Therefore, accommodations for wheelchairs in vehicles are typically installed with aftermarket modifications to a production vehicle. For example, a vehicle may be modified with a lift or the like to load a wheelchair onto a vehicle. Production vehicles typically do not have the ability to accommodate the wheelchair of an occupant in a manner allowing the occupant to sit in the wheelchair in the vehicle, or if they do, significant aftermarket modification is required.

### BRIEF DESCRIPTION OF THE DRAWINGS

FIG. 1 is a cut-away view of a vehicle including a wheelchair-anchor assembly including a track and a shuttle.

FIG. 2 is the cut-away view of the vehicle with a wheelchair in the vehicle.

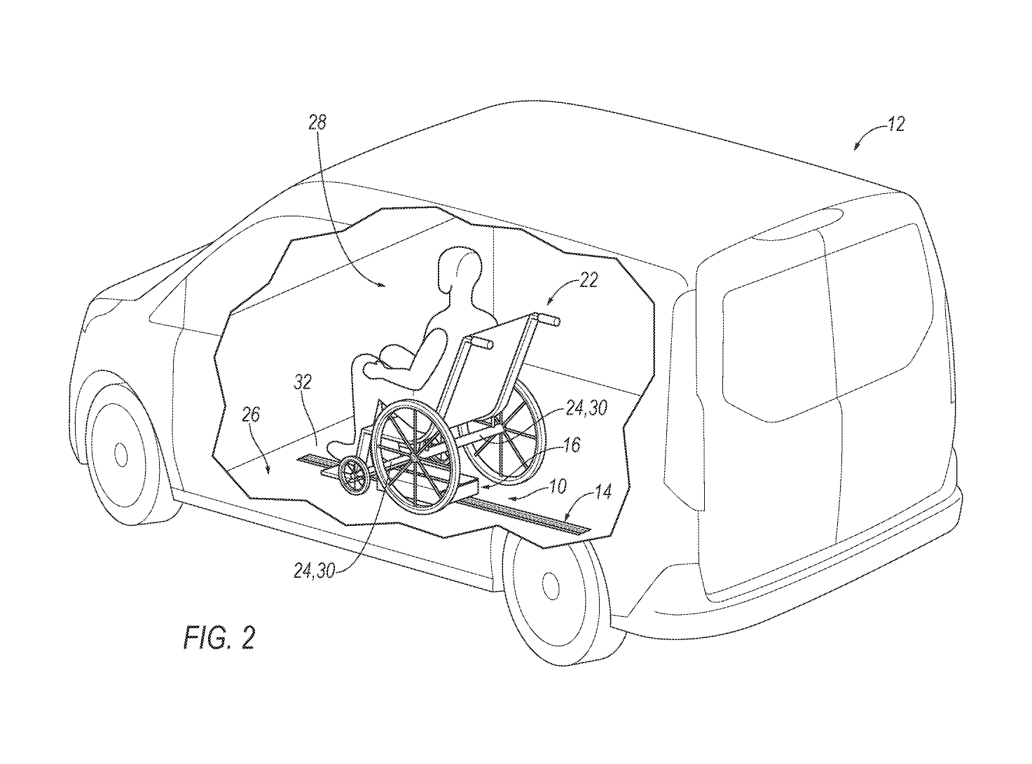

FIG. 3 is a perspective view of a portion of the wheelchair-anchor assembly with hook assemblies in a stowed position.

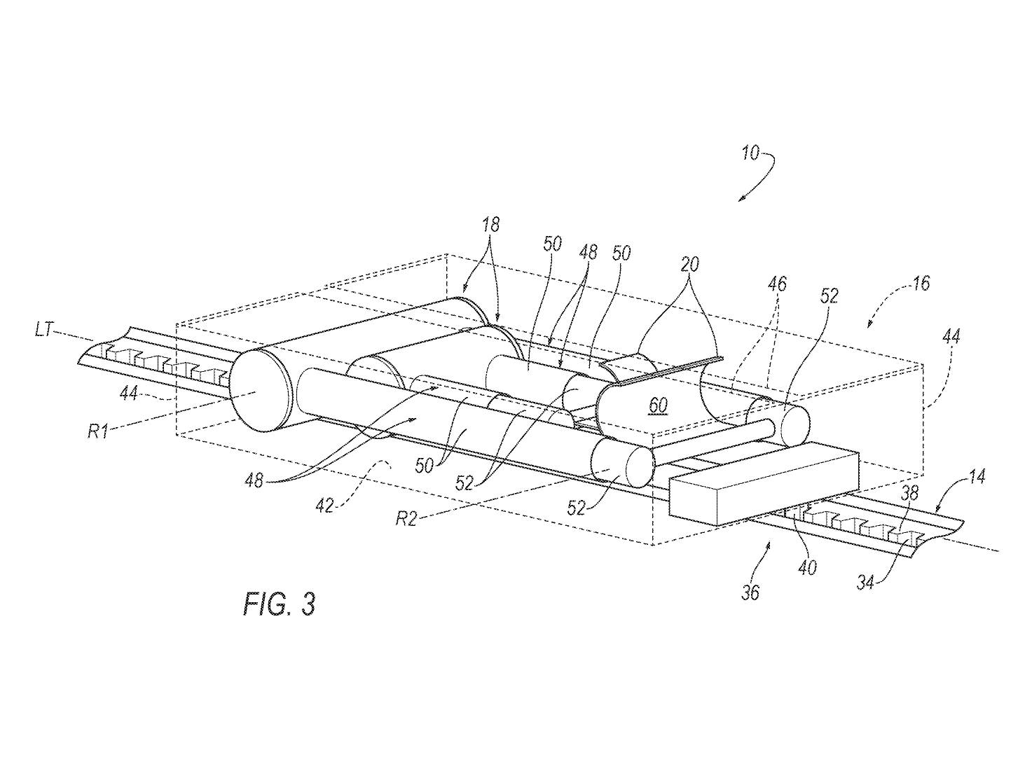

FIG. 4 is a perspective view of a portion of the wheelchair-anchor assembly with the hook assemblies raised from the stowed position.

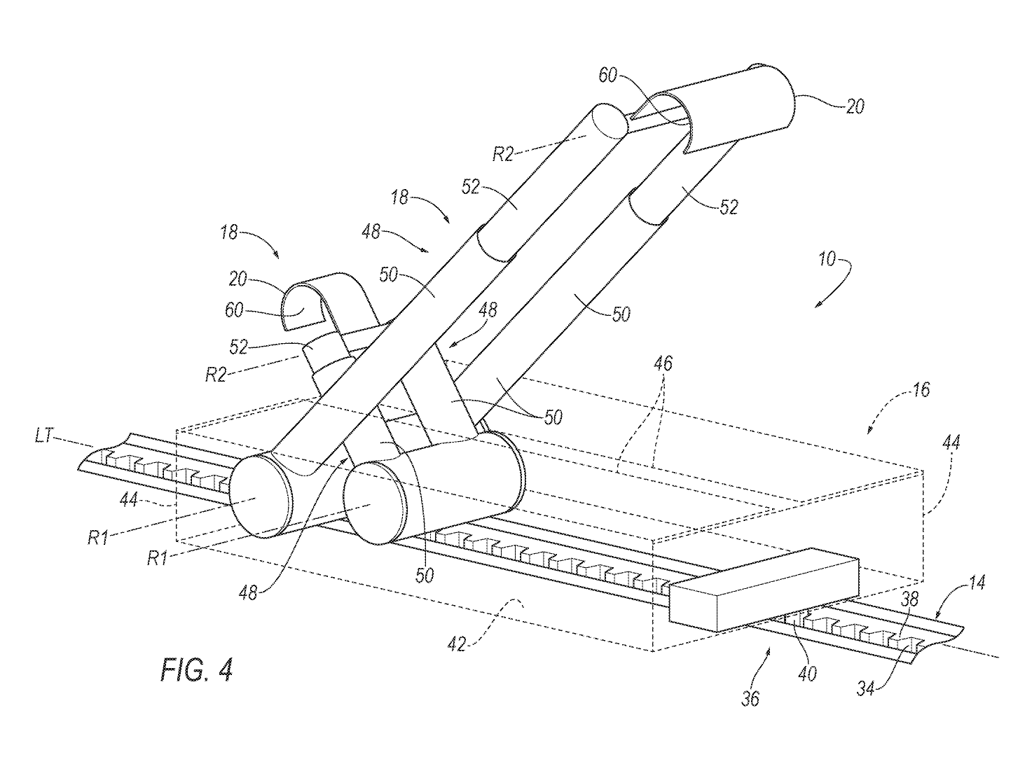

FIG. 5 is a perspective view of a wheelchair with the hook assemblies in hooking positions engaged with axles of the wheelchair.

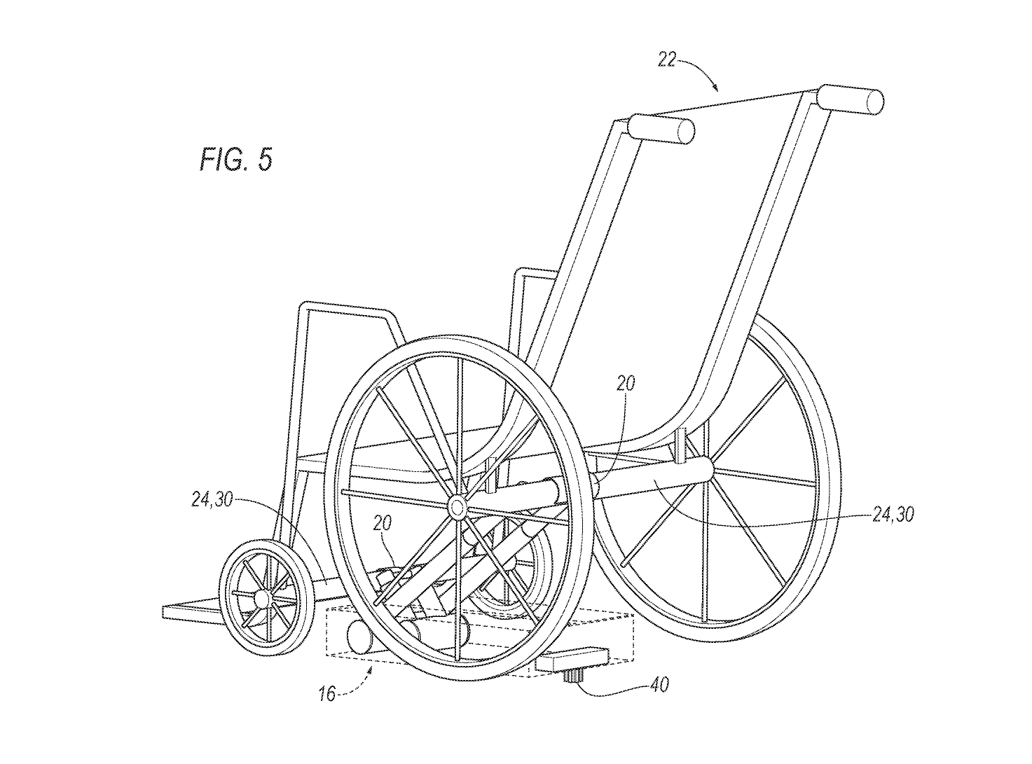

FIG. 6 is a side view of a portion of the vehicle with the hook assemblies in the hooking positions engaged with the axles of the wheelchair.

FIG. 7 is a top view of a portion of the wheelchair-anchor assembly.

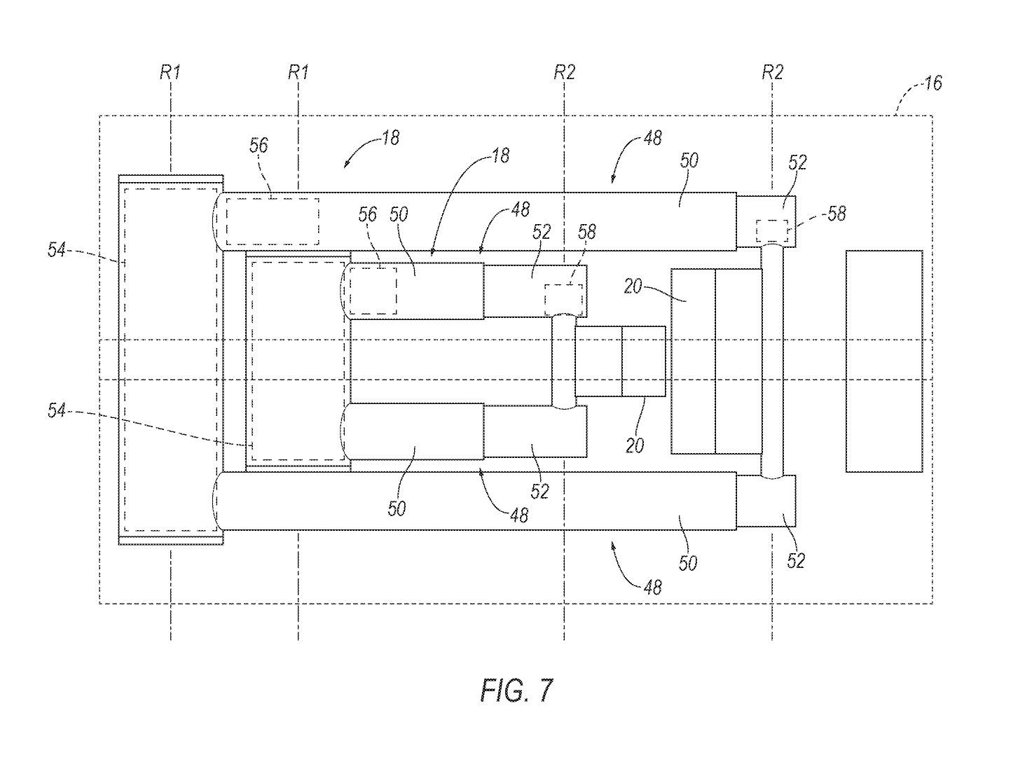

FIG. 8 is a block diagram of a system of the vehicle.

FIG. 9 is a flow chart of a method.

### DETAILED DESCRIPTION

With reference to the Figures, wherein like numerals indicate like parts throughout the several views, a wheelchair-anchor assembly 12 for a vehicle 10 includes a track 14 having a longitudinal axis LT and a shuttle 16 moveably engaged with the track 14. The shuttle 16 is moveable relative to the track 14 along the longitudinal axis LT. Two hook assemblies 18 are adjustably supported by the shuttle 16. The hook assemblies 18 are moveable relative to the shuttle 16 to hooking positions. The hook assemblies 18 each include a hook 20. The hooks 20 oppose each other along the longitudinal axis LT in the hooking positions.

The hook assemblies 18 may be in a stowed position when the vehicle 10 is unoccupied by a wheelchair 22. When a wheelchair 22 enters the vehicle 10, the shuttle 16 is moved along the axis LT of the track 14 to align with the wheelchair 22. When the shuttle 16 is aligned with the wheelchair 22, the hook assemblies 18 move from the stowed position toward hooking components 30, respectively, of the wheelchair 22 to engage the hooking components 30, e.g., axles 24 of the wheelchair 22, in hooking positions. Since the hooks 20 oppose each other along the longitudinal axis LT in the locking positions, the hooks 20 pin the wheelchair 22, e.g., via the axles 24, between the hooks 20 along the longitudinal axis LT.

The vehicle 10 includes a floor 26. In the example shown in the Figures, the floor 26 of the vehicle 10 has a longitudinal axis LF. The longitudinal axis LF of the floor 26 is parallel to the longitudinal axis LT of the track 14 and the shuttle 16 is moveable along the longitudinal axis LF of the floor 26 in the example shown in the Figures. In such examples, the longitudinal axis LT of the track 14 extends along the longitudinal axis LF of the floor 26. Specifically, the longitudinal axis LT of the track 14 may extend along the longitudinal axis LF of the floor 26 spaced from the longitudinal axis LF of the floor 26, as shown in the example in the Figures, or may be on the longitudinal axis LF of the floor 26. The longitudinal axis of the track 14 is the longest dimension of the track 14, i.e., the track 14 is elongated along the longitudinal axis LT of the track 14. The longitudinal axis LF of the floor 26 is the longest dimension of the floor 26, i.e., the floor 26 is elongated along the longitudinal axis LF of the floor 26.

In the example shown in the Figures, the vehicle 10 includes one wheelchair-anchor assembly 12. In other examples, the vehicle 10 may include any suitable number of wheelchair-anchor assemblies 12, i.e., one or more. In examples including more than one wheelchair-anchor assembly 12, the tracks 14 of the respective wheelchair-anchor assemblies 12 may be parallel to each other and may be parallel to the longitudinal axis LF of the floor 26 of the vehicle 10. In such examples, the tracks 14 may be spaced from each other cross vehicle 10 and/or vehicle 10 longitudinally. In the example shown in the Figures, the wheelchair-anchor assembly 12 includes only one shuttle 16 on the track 14. In other examples, the wheelchair-anchor assembly 12 may include more than one shuttle 16 on the same track 14, in which case the shuttles 16 are spaced from each other along the longitudinal axis LT of the track 14.

The vehicle 10 may be any suitable type of automobile, e.g., a passenger or commercial automobile such as a sedan, a coupe, a truck, a sport utility vehicle, a crossover vehicle, a van, a minivan, a taxi, a bus, etc. The vehicle 10 may be configured to receive a wheelchair 22. For example, a passenger compartment 28 of the vehicle 10 may include seatbelts configured to control the kinematics of a wheelchair occupant.

The wheelchair 22 may be any type of personal mobility device that supports a seated occupant and provides mobility to the seated occupant, i.e., the wheelchair 22 transports the seated occupant outside of the vehicle 10 and moves the seated occupant in the passenger compartment 28 during ingress into and egress from the vehicle 10. The wheelchair 22 supports the seated occupant in the passenger compartment 28 during operation of the vehicle 10. The wheelchair 22 may include wheels. As another example, the wheelchair 22 may include a continuous track 14. In such an example, the continuous track 14 is in contact with ground and the wheelchair 22 may include wheels, gears, etc., that transmit force to the continuous track 14. The wheelchair 22 may include a motor operably connected to the wheels and a battery that provides power to the motor. In some examples, the wheelchair 22 may be, for example, an electric mobility scooter.

The wheelchair 22 includes hooking components 30 configured to anchor the wheelchair 22 to a floor 26 of the vehicle 10. In some examples, the hooking components 30 may be specifically designed to anchor the wheelchair 22 to the floor 26, and in other examples, as shown in the example in the Figures, the hooking components 30 may be components of the wheelchair 22 that also perform other functions. As examples, the hooking components 30 may be axles 24 of the wheelchair 22 (as shown in the example in the Figures), wheels of the wheelchair 22, frame members of the wheelchair 22, etc. When the hooks 20 are engaged with the hooking components 30, respectively, the hooks 20 anchor the wheelchair 22 to the floor 26 of the vehicle 10 through the hooking components 30.

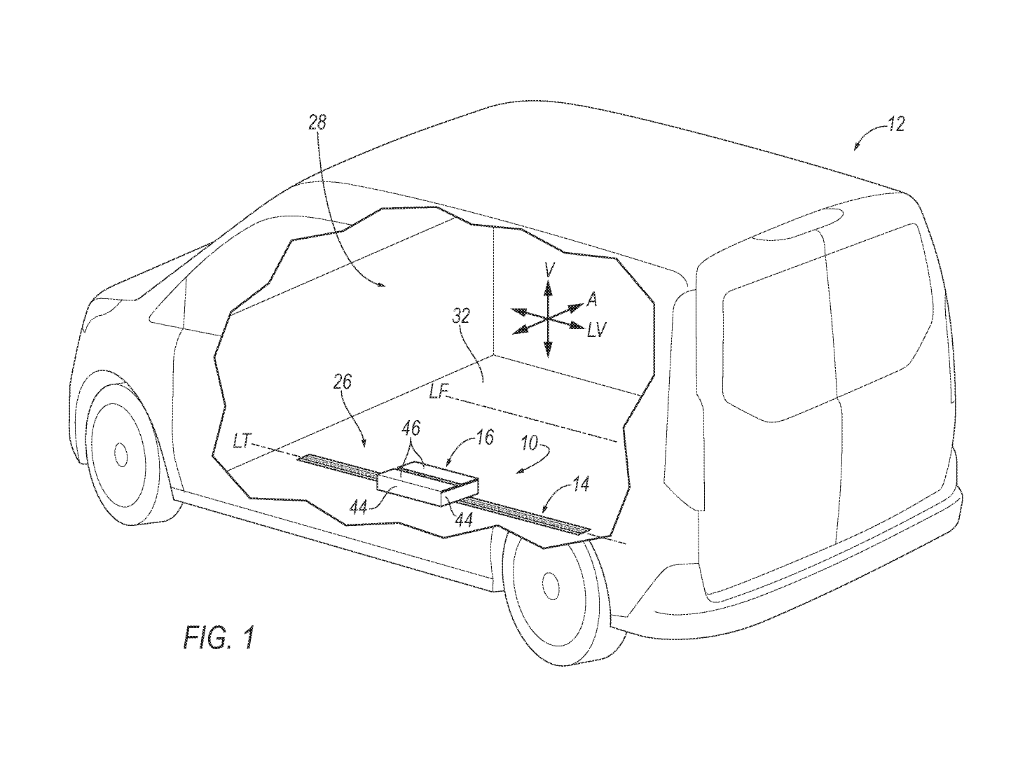

With reference to FIG. 1, the vehicle 10 defines a vehicle-longitudinal axis LV extending between a front end and a rear end of the vehicle 10. The vehicle 10 defines a cross-vehicle axis A extending cross-vehicle from one side to the other side of the vehicle 10. The vehicle 10 defines a vertical axis V extending through the floor 26 and a roof of the vehicle 10. The vehicle-longitudinal axis LV, the vehicle-lateral axis A, and the vertical axis V are perpendicular relative to each other. In the example shown in the Figures, the longitudinal axis of the track 14 and the longitudinal axis LF of the floor 26 are parallel to the longitudinal axis LV of the vehicle 10.

The vehicle body may be of a unibody construction in which a vehicle frame and the vehicle body are unitary (including frame rails, pillars, roof rails, etc.). As another example, the vehicle body and a vehicle frame may have a body-on-frame construction (also referred to as a cab-on-frame construction) in which the vehicle body and vehicle frame are separate components, i.e., are modular, and the body is supported on and affixed to the frame. Alternatively, the vehicle body may have any suitable construction. The vehicle body may be of any suitable material, for example, steel, aluminum, and/or fiber-reinforced plastic, etc.

The vehicle body includes body panels (not numbered). The body panels may include structural panels, e.g., rockers, pillars, roof rails, etc. The body panels may include exterior panels. The exterior panels may present a class-A surface, e.g., a finished surface exposed to view by a customer and free of unaesthetic blemishes and defects. The body panels include, e.g., a floor panel 32, a roof panel, doors, fenders, hood, decklid, etc. The vehicle body may define a passenger cabin to house occupants of the vehicle 10.

The vehicle body includes the floor 26 and may include a roof. The floor 26 defines the lower boundary of the passenger compartment 28 and may extend from the front end of the passenger compartment 28 to the rear end of the passenger compartment 28. The roof may define the upper boundary of the passenger compartment 28 and may extend from the front end of the passenger compartment 28 to the rear end of the passenger compartment 28. In examples including a roof, the floor 26 is below the roof.

The floor 26 may include a floor panel 32. The floor panel 32 may be metal and is fixed to the rest of the vehicle body, e.g., by welding, fastening, etc. The floor 26 may include upholstery facing the passenger compartment 28. The upholstery may include, for example, carpet. The wheelchair 22 is supported directly on the floor 26 of the vehicle 10, e.g., the upholstery, when in the passenger compartment 28. In other words, the wheelchair 22 is in contact with the floor 26, and the weight of the wheelchair 22 is borne by the floor 26.

The track 14 guides movement of the shuttle 16 along the longitudinal axis LT of the track 14. In the example shown in the Figures, the track 14 restricts movement of the shuttle 16 to movement along the longitudinal axis LT of the track 14. The track 14 may include, for example, a channel 34 along the longitudinal axis LT of the track 14. In such an example, a portion of the shuttle 16 may extend into the channel 34. The track 14 is fixed to the floor 26. As an example, the track 14 may be welded, fastened, etc., to the floor panel 32. Part of the track 14 or all of the track 14 may be concealed by the upholstery of the floor 26. As an example, a flexible covering may extend over the channel 34 to prevent entry of dirt and other debris into the channel 34. The flexible covering resiliently covers the channel 34 and is flexible relative to the shuttle 16 so that the shuttle 16 displaces the flexible covering as the shuttle 16 moves along the longitudinal axis LT of the track 14.

The shuttle 16 is moveably engaged with the track 14. Specifically, the shuttle 16 remains engaged with the track 14 and moves relative to the track 14 along the longitudinal axis LT of the track 14. The wheelchair-anchor assembly 12 includes a linear actuator 36 between the shuttle 16 and the track 14. The linear actuator 36 is controlled by a computer 64 of the vehicle 10, as described below, to move the shuttle 16 along the track 14. As one example, as shown in the example in the Figures, the linear actuator 36 includes a gear rack 38 fixed to the track 14 and a pinion gear 40 supported by the shuttle 16 and engaged with the gear rack 38. In such an example, a drive motor is supported by the shuttle 16 and, as controlled by the computer 64, drives the pinion gear 40 to linearly translate the shuttle 16 along the track 14. As another example, the linear actuator 36 may include a lead screw supported by the track 14 and a traveling nut supported by the shuttle 16. In other examples, the linear actuator 36 may be hydraulic, pneumatic, or piezoelectric. In the example shown in the Figures, the linear actuator 36, e.g., the pinion gear 40, extends from the shuttle 16 into the channel 34 of the track 14.

The shuttle 16 may be box shaped. For example, the shuttle 16 may include a bottom 42 and four walls 44 extending upwardly from the bottom 42. The bottom 42 and the four walls 44 may be rigid to support the hook assemblies 18 to transmit force between the track 14 and the hook assemblies 18. The bottom 42 and the four walls 44 may be, for example, metal, reinforced plastic, etc. The shuttle 16 may include two flaps 46 connected to the walls 44 and extending over the four walls 44 to prevent intrusion of dirt and debris. In such an example, the flaps 46 resiliently cover the walls 44 and are flexible relative to the walls 44 and the hook assemblies 18 so that the hook assemblies 18 displace the flaps 46 as the hook assemblies 18 move between the stowed position and a hooking position.

Each hook assembly 18 can be independently moved from the stowed position to a hooking position. In the stowed position, the hook assemblies 18 may be recessed in the shuttle 16, e.g., recessed below top edges of the walls below the flaps 46. Each hooking assembly is moveable to various hooking positions based on the location of the wheelchair 22 in the passenger compartment 28, e.g., based on the position of the hooking components 30 (e.g., axles 24) of the wheelchair 22 assembly. Since the hook assemblies 18 are independently moveable, the hook assemblies 18 can be positioned to engage wheelchair 22 assemblies of a variety of sizes, shapes, and configurations.

Each hook assembly 18 includes an arm 48 rotatably connected to the shuttle 16 and the hook 20 is supported by the arm 48 of the respective hook assembly 18. In the example shown in the Figures, the arm 48 includes a first member 50 and a second member 52 translationally extendable from the first member 50. The first member 50 is supported by the shuttle 16, i.e., the weight of the first member 50 is borne by the shuttle 16, and the second member 52 is supported by the first member 50, i.e., the weight of the second member 52 is borne by the first member 50. The arm 48 (specifically the first member 50 and the second member 52 in the example shown in the Figures) is rigid to impart a force on the hooking components 30, e.g., the axles 24, of the wheelchair 22 to anchor the wheelchair 22 to the track 14 in hooking positions.

The hook 20 is rotatably supported by the second member 52, i.e., the weight of the hook 20 is borne by the second member 52 and the hook 20 is selectively rotatable relative to the second member 52. In the example shown in the Figures, the arm 48 is rotated relative to the shuttle 16, the second member 52 is translated relative to the first arm 48, and the hook 20 is rotated relative to the second arm 48 to move the hook assembly 18 from the stowed position to the hooking position as powered by actuators controlled by the computer 64, as described further below. In the example shown in the Figures, each hook assembly 18 includes two arms 48 and the hook 20 extends between the two arms 48. In other examples, the hook assembly 18 may include any suitable number of arms 48, i.e., one or more.

The hook assemblies 18 are rotatable relative to the shuttle 16 about rotational axes R1, respectively, between the stowed position and a hooking position. The rotational axes R2 f the hook assemblies 18, respectively, are spaced from each other along the longitudinal axis LT of the track 14. The rotational axes R1 are nonparallel to the longitudinal axis LF of the floor 26. The rotational axes R1 are in vertical planes, respectively, that are transverse, e.g., perpendicular, to a vertical plane on the longitudinal axis LF of the floor 26.

Each hook assembly 18 includes a first rotational actuator 54 between the shuttle 16 and the respective hook assembly 18. For example, the first rotational actuator 54 may be between the shuttle 16 and one or more arms 48 of the hook assembly 18, e.g., both arms 48 in the example shown in the Figures. The first rotational actuator 54 may be connected to the first member 50 of the arm 48 and the shuttle 16, as shown in the example in the Figures. The first rotational actuator 54 is engaged with the shuttle 16. For example, each first rotational actuator 54 may include a housing that is anchored, e.g., fastened, welded, etc., to the shuttle 16, e.g., the bottom of the shuttle 16 between the walls of the shuttle 16. The first rotational actuators 54 may be of any suitable type, e.g., electric, hydraulic, pneumatic, etc.

The two first rotational actuators 54, i.e., one first rotational actuator 54 of each hook assembly 18, are independently operable to independently move the hook assemblies 18 relative to the shuttle 16. Based on the detected position of hooking components 30, e.g., axles 24, of a wheelchair 22, the two first rotational actuators 54 are moveable independently to engage the hooking components 30, respectively.

In the example shown in the Figures, the arms 48 of the hook assemblies 18 are each translationally extendable relative to the shuttle 16. The arm 48 or a portion of the arm 48 moves in a straight line or generally in a straight line (to accommodate for fits and tolerances) during translational movement. In the example shown in the Figures, the second member 52 is translationally extendable from the first member 50. Specifically, the second member 52 slides along the first member 50. The first member 50 and the second member 52 may be telescopically engaged, i.e., the second member 52 may be telescopically received in the first member 50 or the first member 50 may be telescopically received in the second member 52.

Each hook assembly 18 includes a linear actuator 56 for extending and retracting the arm(s) 48 relative to the shuttle 16. In the example shown in the Figures, the linear actuator 56 is between the first member 50 and the second member 52 to extend the second member 52 from the first member 50 and to retract the second member 52 to the first member 50. In examples in which the hook assembly 18 includes two arms 48, one or both of the arms 48 may include a linear actuator 56. The linear actuators 56 may be of any suitable type, e.g., mechanical (e.g., lead screw supported by the track 14 and a traveling nut), electronic, hydraulic, pneumatic, etc. The linear actuator 56 may be in the first member 50 and/or the second member 52. The two linear actuators 56, i.e., one linear actuator 56 of each hook assembly 18, are independently operable to independently move the second members 52 relative to the first members 50.

Each hook assembly 18 includes a hook 20 supported by the arm 48. The hook 20 is rotatably adjustable relative to the arm 48. In the example shown in the Figures, each hook assembly 18 includes two arms 48 and the respective hook 20 extends from one arm 48 to the other arm 48 of the hook assembly 18.

Each hook assembly 18 includes a second rotational actuator 58 between the arm 48 and the hook 20. For example, the second rotational actuator 58 may be between the hook 20 and one or more arms 48 of the hook assembly 18, e.g., both arms 48 in the example shown in the Figures. The second rotational actuator 58 may be connected to the second member 52 of the arm 48 and the hook 20, as shown in the example in the Figures. The second rotational actuator 58 is engaged with the hook 20 and the second member 52 of the arm 48 to rotate the hook 20 relative to the second member 52 about rotational axes R2. The second rotational actuators 58 may be of any suitable type, e.g., electronic, hydraulic, pneumatic, etc. The adjectives “first” and “second” are used herein, including with respect to the rotational actuators, as identifiers and do not indicate order or importance.

The two second rotational actuators 58, i.e., one second rotational actuator 58 of each hook assembly 18, are independently operable to independently move the hooks 20 relative to the respective arms 48. Based on the detected position of hooking components 30, e.g., axles 24, of a wheelchair 22, the two second rotational actuators 58 are moveable independently to engage the hooking components 30, respectively. The first rotational actuators 54, the linear actuators 56, and the second rotational actuators 58 are each operable independent of each other to independently move the hooks 20 in multiple degrees of freedom relative to the hooking components 30 of the wheelchair 22.

The hooks 20 are designed to engage respective hooking components 30 of wheelchair 22. Specifically, the hooks 20 are designed to anchor the wheelchair 22 to the floor 26 of the vehicle 10 through the hooking components 30 when the hooks 20 are engaged with the hooking components 30. The hooks 20 may directly contact the hooking components 30, respectively, when engaged with the hooking components 30. The hooks 20 may have a curved surface designed, i.e., sized, shaped, and positioned, to engage the hooking components 30 of the wheelchair 22. In the example shown in the Figures, the hooking components 30 of the wheelchair 22 are axles 24 that include cylindrical surfaces extending in a lateral direction of the wheelchair 22, and the hooks 20 each include a curved surface 60 that receives and extends around the axle 24 when the hook 20 is engaged with the axle 24.

The hooks 20 oppose each other along the longitudinal axis LT in the hooking positions. In other words, one hook 20 opposes movement of the wheelchair 22 in a first direction along the longitudinal axis LT, and the other hook 20 opposes movement of the wheelchair 22 in a second direction along the longitudinal axis LT opposite the first direction. In the example shown in the Figures, in the hooking positions, one hook 20 opposes movement of the wheelchair 22, through the axle 24, in a vehicle-forward direction and the other hook 20 opposes movement of the wheelchair 22, through the axle 24, in a vehicle-rearward direction. In some examples, both hooks 20 can each, individually, oppose movement of the wheelchair 22 in both the vehicle-forward direction and the vehicle-rearward direction. In such examples, the hooks 20 are designed to engage a vehicle-forward side and a vehicle-rearward side of the hooking components 30, e.g., the axles 24.

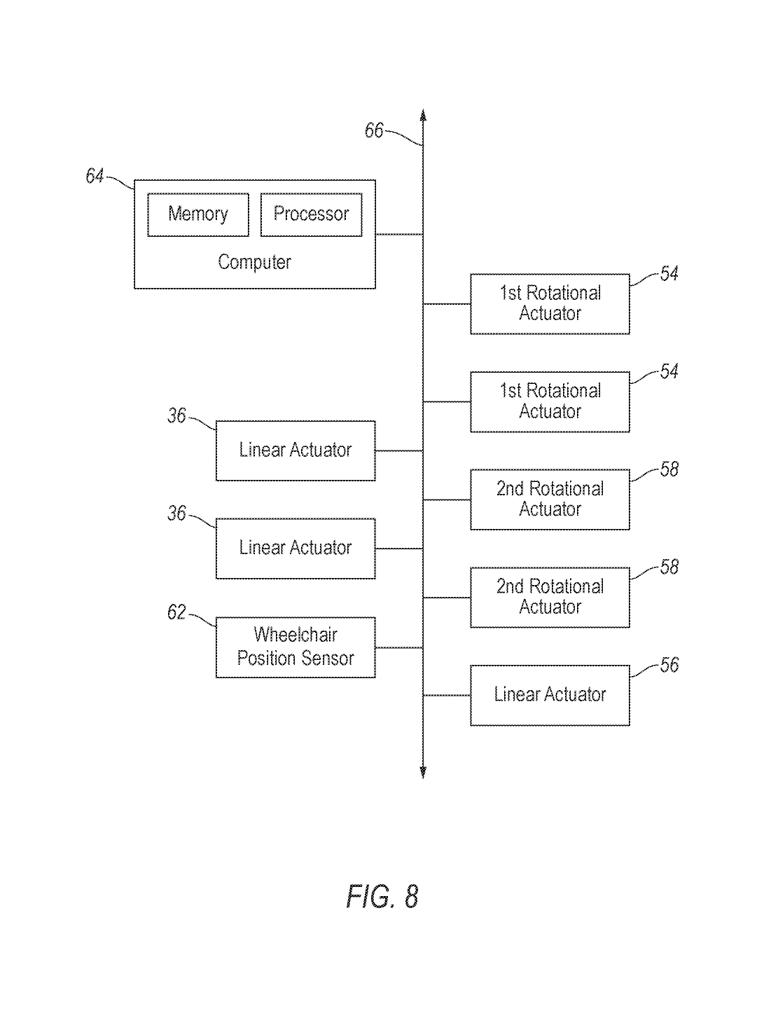

With reference to FIG. 8, the vehicle 10 include wheelchair position sensors 62 to identify the presence and a position of a wheelchair 22 in the vehicle 10. The wheelchair position sensors 62 may be in communication with the vehicle computer 64 of the vehicle 10. The wheelchair position sensors 62 may send a signal to the vehicle computer 64 to indicate that a wheelchair 22 is present in the vehicle 10 and the position of the wheelchair 22. Specifically, the wheelchair position sensors 62 may identify the location of the hooking components 30 of the wheelchair 22 in the passenger compartment 28. The wheelchair position sensors 62 may be any suitable type of sensors or combination of sensors including cameras, radar, LIDAR, weight sensors, positions sensors of the wheelchair-anchor assembly 12 (e.g., rotary encoders, Hall-effect sensors, etc.), etc.

With continued reference to FIG. 8, the computer 64 includes a processor and a memory storing instructions executable by the processor. The memory includes one or more forms of computer readable media, and stores instructions executable by the computer 64 for performing various operations, including as disclosed herein. The computer 64 may be a restraints control module. The computer 64 can be a generic computer with the processor and the memory as described above and/or may include an electronic control unit ECU or controller for a specific function or set of functions, and/or a dedicated electronic circuit including an ASIC (application specific integrated circuit) that is manufactured for a particular operation, e.g., an ASIC for processing sensor data and/or communicating the sensor data. In another example, the computer 64 may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in the computer 64.

The vehicle computer 64 is generally arranged for communications on a vehicle communication network 66 that can include a bus in the vehicle 10 such as a controller area network CAN or the like, and/or other wired and/or wireless mechanisms. Alternatively or additionally, in cases where the computer 64 includes a plurality of devices, the vehicle communication network 66 may be used for communications between devices represented as the vehicle computer 64 in this disclosure. Further, as mentioned below, various controllers and/or sensors may provide data to the vehicle computer 64 via the vehicle communication network 66.

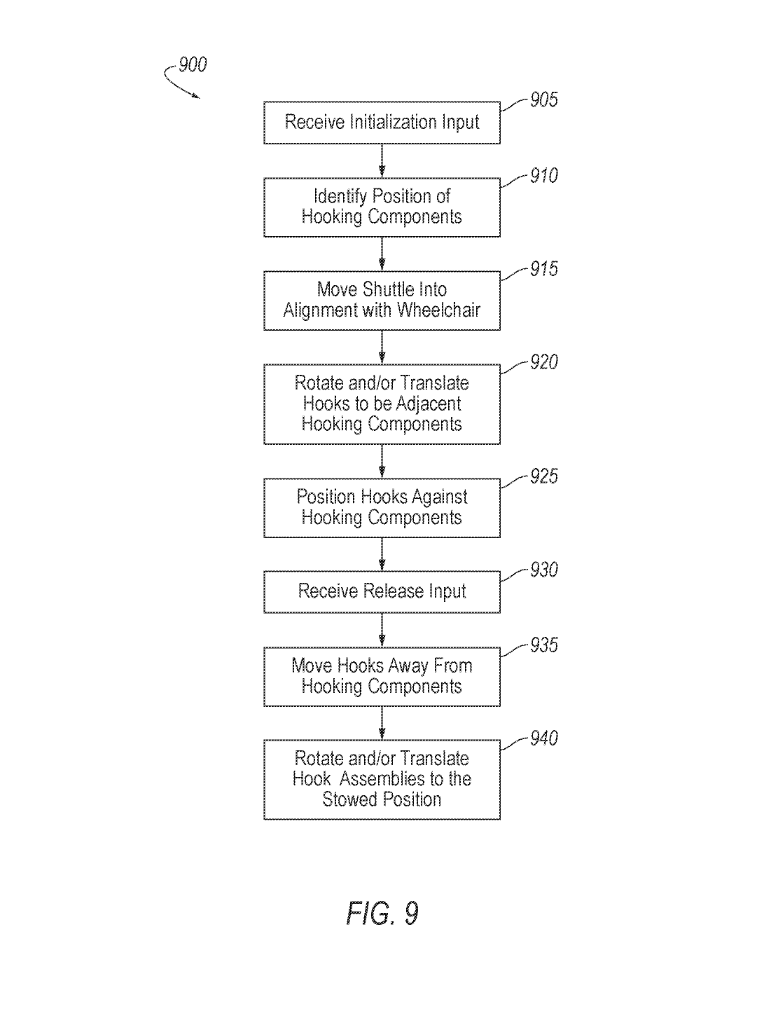

With reference to FIG. 9, the computer 64 stores instructions to control components of the vehicle 10 according to the method 900. Specifically, the method 900 includes moving the wheelchair-anchor assembly 12 to engage the wheelchair 22 to anchor the wheelchair 22 to the floor 26 of the vehicle 10. Any use of “based on” herein, including with reference to method 900, indicates a causal relationship, not merely a temporal relationship.

With reference to block 905, the method 900 includes receiving initialization input indicating that a wheelchair 22 is in the passenger compartment 28 and is positioned to be engaged by the wheelchair-anchor assembly 12. As described further below, the method moves the wheelchair-anchor assembly 12 relative to the floor 26 and the wheelchair 22 to engage the wheelchair 22 in response to the initialization input. As an example, the initialization input may be manually entered by an occupant of the vehicle 10, such as an occupant of the wheelchair 22, through an input interface such as a button, switch, touch screen voice control, motion control, etc. As another example, the initialization input may be automatically identified by the computer 64 through input from the wheelchair position sensors 62.

With reference to block 910, the method 900 includes identifying the position of hooking components 30 of the wheelchair 22 in the passenger compartment 28. The position of the hooking components 30 may be identified by the wheelchair position sensors 62. The wheelchair position sensors 62 may identify the position of the hooking components 30 of wheelchairs 22 of varying size, shapes, and configurations. In other words, the wheelchair 22 positions sensors are operable to accommodate for various positions of the hooking components 30 of different wheelchairs 22. The identification of the position of the hooking components 30 may be in response to the initialization input and/or may be independent of the initialization input, e.g., by continuous monitoring.

With reference to block 915, the method 900 includes adjusting the shuttle 16 along the longitudinal axis LF of the floor 26 based on a position of a wheelchair 22 along the longitudinal axis LF of the floor 26. Block 915 includes aligning the shuttle 16 with the wheelchair 22, i.e., positioning the shuttle 16 such that the two hook assemblies 18 are located to move to hooking assemblies to hooking positions engaged with the hooking components 30, respectively, of the wheelchair 22. The computer 64 controls the linear actuator 36 to move the shuttle 16 relative to the track 14 and the floor 26. The position of the shuttle 16 is based on the position of the wheelchair 22, e.g., the position of the hooking components 30 of the wheelchair 22, detected in block 910.

With reference to blocks 920 and 925, when the shuttle 16 is aligned with the wheelchair 22, the method 900 includes adjusting the position of the hook assemblies 18 relative to the shuttle 16 to engage the hook assemblies 18 with hooking components 30 of the wheelchair 22, respectively, based on the position of the wheelchair 22, and specifically, based on the position of the hooking components 30 of the wheelchair 22, e.g., the axles 24. The hooking position is identified based on the position of the wheelchair 22, e.g., the position of the hooking components 30 of the wheelchair 22, detected in block 910.

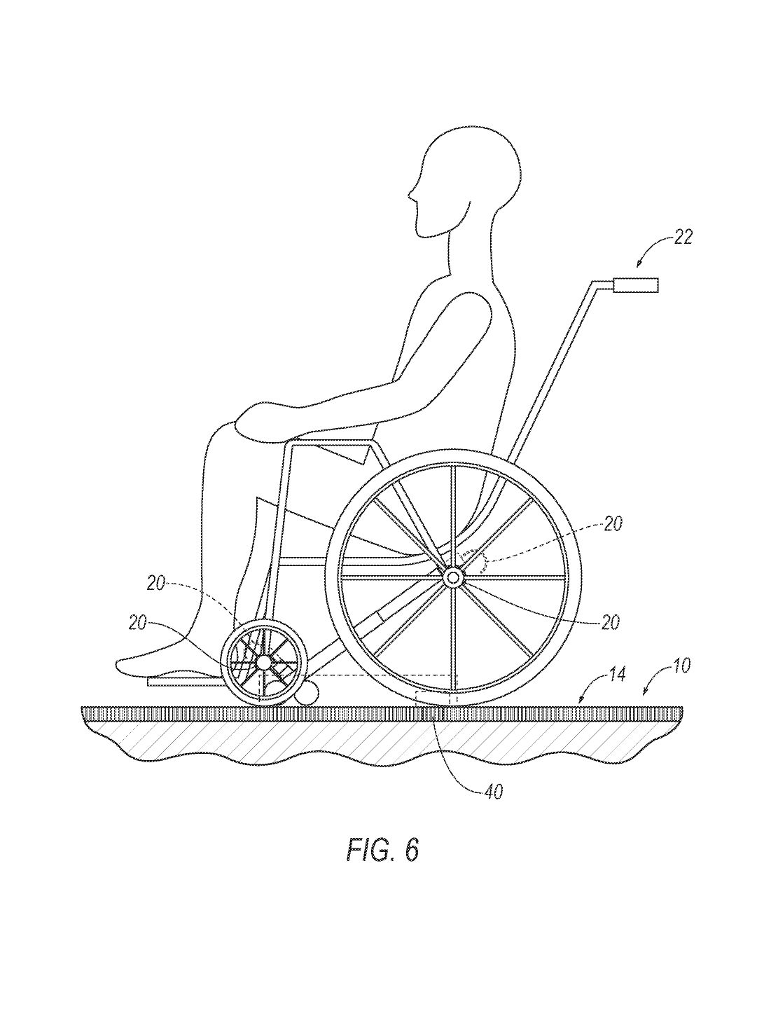

In block 920, the method 900 includes actuating one or more of the first rotational actuators 54, one or more of the second rotational actuators 58, and/or one or more of the linear actuators 56 to position the hooks 20 to be adjacent the hooking components 30, as shown in broken lines in FIG. 6. In block 925, the method 900 includes actuating one or more of the first rotational actuators 54, one or more of the second rotational actuators 58, and/or one or more of the linear actuators 56 to retract the hooks 20 toward the hooking components 30 to clamp the hooking components 30 between the hooks 20 in hooking positions, as shown in solid lines in FIG. 6. The hooking position may be identified by the wheelchair position sensors 62 and/or sensors in hook assembly 18, e.g., pressure sensors, load sensors, etc.

The hook assemblies 18 may remain in the hooking positions during operation of the vehicle 10. After operation of the vehicle 10, e.g., when the vehicle 10 is stopped at a destination, the hook assemblies 18 may be disengaged from the hooking components 30 to release the wheelchair 22 from the floor 26. The method 900 includes receiving a release input in block 930 and releasing the hooking components 30 in block 935.

In block 930, the release input may manually entered by an occupant of the vehicle 10, such as an occupant of the wheelchair 22, through an input interface such as a button, switch, touch screen voice control, motion control, etc. As another example, the release input may be automatically identified by the computer 64, e.g., when the vehicle 10 is parked, turned off, etc.

In block 935, the method 900 includes actuating one or more of the first rotational actuators 54, one or more of the second rotational actuators 58, and/or one or more of the linear actuators 36 to position the hooks 20 to be spaced from the hooking components 30 (e.g., returning to the position shown in broken lines in FIG. 6. In block 940, the method 900 includes actuating one or more of the first rotational actuators 54, one or more of the second rotational actuators 58, and/or one or more of the linear actuators 56 to position the hook assemblies 18 to the stowed position.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A vehicle, comprising:
a floor having a longitudinal axis;
a shuttle movable relative to the floor along the longitudinal axis; and
two hook assemblies adjustably supported by the shuttle and moveable relative to the shuttle to hooking positions;
the hook assemblies each including a hook, the hooks opposing each other along the longitudinal axis in the hooking positions.

2. The vehicle as set forth in claim 1, wherein the hook assemblies are rotatable relative to the shuttle about rotational axes, respectively, that are nonparallel to the longitudinal axis of the floor.

3. The vehicle as set forth in claim 2, wherein each hook assembly includes a rotational actuator engaged with the shuttle.

4. The vehicle as set forth in claim 1, wherein the hook assemblies each include an arm extendable relative to the shuttle.

5. The vehicle as set forth in claim 4, wherein the arm of each hook assembly includes a first member rotatably supported by the shuttle and a second member slidably engaged with the first member.

6. The vehicle as set forth in claim 5, further comprising, for each hook assembly, a linear actuator between the first member and the second member.

7. The vehicle as set forth in claim 1, wherein each hook assembly includes an arm and a hook supported by and rotatably adjustable relative to the arm.

8. The vehicle as set forth in claim 7, further comprising, for each hook assembly, a rotational actuator between the arm and the hook.

9. The vehicle as set forth in claim 1, further comprising a track fixed to the floor and elongated along the longitudinal axis, the shuttle being moveably engaged with the track.

10. The vehicle as set forth in claim 1, further comprising a computer having a processor and memory storing instructions executable by the processor to adjust the shuttle along the longitudinal axis of the floor based on a position of a wheelchair along the longitudinal axis.

11. The vehicle as set forth in claim 10, wherein the instructions include instructions to adjust the position of the hook assemblies relative to the shuttle to engage the hook assemblies with axles of the wheelchair, respectively, based on the position of the wheelchair.

12. A wheelchair-anchor assembly, comprising:
a track having a longitudinal axis;
a shuttle moveably engaged with the track and moveable relative to the track along the longitudinal axis; and
two hook assemblies adjustably supported by the shuttle and moveable relative to the shuttle to hooking positions;
the hook assemblies each including a hook, the hooks opposing each other along the longitudinal axis in the hooking positions.

13. The wheelchair-anchor assembly as set forth in claim 12, wherein the hook assemblies are rotatable relative to the shuttle about rotational axes, respectively, that are nonparallel to the longitudinal axis of the track.

14. The wheelchair-anchor assembly as set forth in claim 13, wherein the rotational axes are parallel to each other.

15. The wheelchair-anchor assembly as set forth in claim 13, wherein each hook assembly includes a rotational actuator engaged with the shuttle.

16. The wheelchair-anchor assembly as set forth in claim 13, wherein:
the hook assemblies each include an arm extendable relative to the shuttle; and
for each hook assembly, the hook is supported by and rotatably adjustable relative to the arm.

17. The wheelchair-anchor assembly as set forth in claim 12, wherein the hook assemblies each include an arm extendable relative to the shuttle.

18. The wheelchair-anchor assembly as set forth in claim 17, wherein each hook assembly includes a first member rotatably supported by the shuttle and a second member slidably engaged with the first member.

19. The wheelchair-anchor assembly as set forth in claim 12, wherein each hook assembly includes an arm and a hook supported by and rotatably adjustable relative to the arm.

20. The wheelchair-anchor assembly as set forth in claim 19, further comprising, for each hook assembly, a rotational actuator between the arm and the hook.
